(19) United States
(12) Patent Application Publication
(10) Pub. No.: US 2026/0065428 A1
(43) Pub. Date: Mar. 5, 2026

(54) IMAGE FIELD EXTENSION SYSTEM AND METHOD

(71) Applicant: Lenovo (United States) Inc., Morrisville, NC (US)

(72) Inventors: Sean C. Kelly, Barrington, IL (US); Jeffrey E Skinner, Raleigh, NC (US); Lincoln Hancock, Raleigh, NC (US); Ellis Anderson, Greensboro, NC (US)

(21) Appl. No.: 18/797,691

(22) Filed: Aug. 8, 2024

(51) Int. Cl. G06T 5/60; G06T 5/50

(52) U.S. Cl. CPC G06T 5/60; G06T 5/50; G06T 2207/20084; G06T 2207/20132

(57) ABSTRACT

An image field extension system and method obtain an input image captured by a camera. The input image depicts an imaged scene. The system and method determine that a crop window, positioned to frame a portion of the input image, extends beyond an edge of the input image and defines a void area within the crop window. The system and method input the input image to a generative artificial intelligence (AI) algorithm. The generative AI algorithm is configured to analyze the input image and generate synthesized image data to fill the void area in the crop window. The generative AI algorithm is configured to generate the synthesized image data based on content in the input image to represent a plausible extension of the imaged scene.

### FIELD

The present disclosure generally relates to electronic devices and systems for automatically editing, rendering, and displaying image data, such as for video conferences, video recording, and video streaming.

### BACKGROUND OF THE INVENTION

Cameras are used for video conferencing, video livestreaming, video recording, and capturing still images of one or more users or other subjects located in a field of view of the camera. Some image editing systems may frame and crop image data captured by the camera so that a resultant cropped image frame depicts only a portion of the camera's field of view. The image editing systems may automatically frame and crop the image data by positioning a crop window based on one or more subjects depicted in the image. For example, a video conference system may auto-frame and crop image data to position an attendee or participant of a video conference at the center of a crop window. It may be aesthetically desirable for attendees of the video conference to view other attendees in respective individual image frames, with each attendee generally centered in the frame. In a scenario in which a single camera captures multiple different attendees of a video conference that are located in the same room, the video conference system may automatically frame and crop the image data captured by the camera to generate a different image frame for each of the attendees within the camera's field of view.

There are situations in which a desired image crop window extends beyond an edge of the camera's field of view. For example, in the scenario described above, if a first attendee in the room is located near a first edge of the camera's field of view, a portion of the crop window positioned relative to the first attendee may be outside of the camera's field of view. As a result, an end portion of the image frame for the first attendee may have no image data provided by the camera. Due to the portion of the frame that lacks image data, when displayed the image frame specific to the first attendee may look different than the displayed image frames corresponding to other attendees of a video conference. For example, the first attendee may not be centered in the frame. Furthermore, it may be evident that a section of the image appears chopped off.

Although repositioning the camera or changing settings of the camera could be used to move the depicted subjects in the imaged environment (e.g., attendees of a video conference) away from the edges of the field of view, these adjustments are not always available or desirable. For example, the camera may be mounted at a fixed position that is difficult to adjust or desirable to remain in the set position for future use of the camera to avoid repeated adjustments. In another example, the camera may not be readily accessible to a user to manipulate. Furthermore, it may not be available or desirable for the subjects in the imaged environment to move towards the center of the camera's field of view. IN the example scenario described above, if there are multiple attendees within the field of view that are afforded different respective image frames, the attendees may be spaced apart at prescribed locations around a table and may not be able to move closer to one another to all be a sufficient distance from the edges of the field of view. A need remains for constructively extending the imaged field of view of a camera without adjusting the camera.

### SUMMARY

In accordance with an example or aspect, an image field extension system is provided that includes a memory and one or more processors operably connected to the memory. The memory is configured to store program instructions. The program instructions are executable by the one or more processors to obtain an input image captured by a camera. The input image depicts an imaged scene. The program instructions are executable by the one or more processors to determine that a crop window, positioned to frame a portion of the input image, extends beyond an edge of the input image and defines a void area within the crop window. The program instructions are executable by the one or more processors to input the input image to a generative artificial intelligence (AI) algorithm. The generative AI algorithm is configured to analyze the input image and generate synthesized image data to fill the void area in the crop window. The generative AI algorithm is configured to generate the synthesized image data based on content in the input image to represent a plausible extension of the imaged scene.

In an example, the generative AI algorithm may generate the synthesized image data to represent a background environment of the imaged scene. In an example, the one or more processors may position the crop window relative to the input image based on a subject in a foreground environment of the imaged scene. For example, the one or more processors may analyze the input image to detect the subject in the foreground environment, and may position the crop window relative to the input image so that the subject is centered within the crop window.

In an example, the one or more processors may produce a composite image having dimensions of the crop window. A first area of the composite image may be defined by the portion of the input image that aligns with the crop window, and a second area of the composite image may be defined by the synthesized image data. The one or more processors may communicate the composite image to a remote computer device for display. The composite image may be a composite background image. The one or more processors may overlay image data depicting a foreground environment of the imaged scene over the composite background image. The one or more processors may generate multiple image frames that depict a subject in the imaged scene in front of the composite background image at different times. The one or more processors may obtain a second input image and produce an updated composite image based on the second input image in response to the one or more processors detecting occurrence of a designated triggering event.

In an example, responsive to determining that a subject in a foreground environment of the imaged scene extends into the void area of the crop window, the generative AI algorithm may generate the synthesized image data within the void area to depict clothing of the subject. In an example, the generative AI algorithm may analyze both the portion of the input image that is within the crop window and a second portion of the input image that is outside of the crop window to generate the synthesized image data to fill the void area of the crop window. The one or more processors may obtain a frame parameter that indicates dimensions of the crop window, and may input the frame parameter to the generative AI algorithm so the generative AI algorithm generates the synthesized image data to fill the void area based on the dimensions of the crop window.

In accordance with an example or aspect, a method of extending an image field is provided. The method includes obtaining an input image captured by a camera. The input image depicts an imaged scene. The method includes determining that a crop window, positioned to frame a portion of the input image, extends beyond an edge of the input image and defines a void area within the crop window. The method includes inputting the input image to a generative artificial intelligence (AI) algorithm. The generative AI algorithm is configured to analyze the input image and generate synthesized image data to fill the void area in the crop window. The generative AI algorithm is configured to generate the synthesized image data based on content in the input image to represent a plausible extension of the imaged scene.

In an example, the method may include producing a composite image having dimensions of the crop window. A first area of the composite image is defined by the portion of the input image that aligns with the crop window, and a second area of the composite image is defined by the synthesized image data. The method may include communicating the composite image to a remote computer device for display. In an example, the composite image may be a composite background image, and the method may include generating multiple image frames of a video by overlaying, over the composite background image, foreground image data depicting a subject of the imaged scene at different times. In an example, the method may include analyzing the input image that is obtained to detect a subject in a foreground environment of the imaged scene, and positioning the crop window relative to the input image so that the subject is centered within the crop window. The method may include obtaining a frame parameter that indicates dimensions of the crop window, and inputting the frame parameter to the generative AI algorithm so the generative AI algorithm generates the synthesized image data to fill the void area based on the dimensions of the crop window.

In accordance with an example or aspect, a computer program product is provided that includes a non-transitory computer readable storage medium. The non-transitory computer readable storage medium includes computer executable code configured to be executed by one or more processors to obtain an input image captured by a camera. The input image depicts an imaged scene. The computer executable code is configured to be executed by one or more processors to determine that a crop window, positioned to frame a portion of the input image, extends beyond an edge of the input image and defines a void area within the crop window. The computer executable code is configured to be executed by one or more processors to input the input image to a generative artificial intelligence (AI) algorithm. The generative AI algorithm is configured to analyze the input image and generate synthesized image data to fill the void area in the crop window. The generative AI algorithm is configured to generate the synthesized image data based on content in the input image to represent a plausible extension of the imaged scene.

In an example, the computer executable code may be executed by the one or more processors to produce a composite image having dimensions of the crop window. A first area of the composite image may be defined by the portion of the input image that aligns with the crop window, and a second area of the composite image may be defined by the synthesized image data.

### BRIEF DESCRIPTION OF THE DRAWINGS

FIG. 1 illustrates a computer device that displays a graphical user interface (GUI) for a video conference.

FIG. 2 is a block diagram of an image field extension system according to an embodiment.

FIG. 3 illustrates an example image that is captured by a camera.

FIG. 4 illustrates a crop window superimposed on the image according to an embodiment.

FIG. 5 is a block diagram showing a function of a generative artificial intelligence (AI) algorithm according to an embodiment.

FIG. 6 shows a first composite image that may be generated by a controller of the image field extension system based on the image according to an embodiment.

FIG. 7 shows a second composite image that may be generated by the controller of the image field extension system based on the image according to an embodiment.

FIG. 8 shows an example image within a crop window.

FIG. 9 shows a composite image that may be generated by the controller of the image field extension system based on the image in FIG. 8 according to an embodiment.

FIG. 10 is a flow chart of a method of extending an image field according to an embodiment.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

References herein to “computer device”, unless specified, shall mean any of various types of hardware devices that perform processing operations, such as personal computers, standalone video conference hub devices, computer workstations, and the like. The personal computers may include laptop (e.g., notebook) computers, desktop computers, tablet computers, smartphone computers, wearable computers, and the like. References herein to “video conference” shall mean live video-based communications between two or more people in different locations using video-enabled computer devices. Video conferences can include calls, meetings, presentations, and the like.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The embodiments described herein provide an image field extension system that can extend a native field of view of a camera by synthesizing content. For example, the image field extension system may extend the imaged field by generating new image data that is plausibly similar to content in the scene. The image field extension system may analyze the image data in an image to determine the new content that is generated to extend the field. The synthesized image data may be plausible content that conceivably could be part of the imaged scene, although the new content may not accurately reflect the portion of the imaged scene that is beyond the camera's field of view. For example, the synthesized content is not generated by a camera (e.g., is not generated by light impinging on an image sensor). As used herein, the image data captured within the field of view of a camera is referred to as ground truth image data because the image data accurately depicts objects and locations of the objects that are present in an imaged scene in the real world. The synthesized image data is plausible image data that is a reasonable or believable extension of the ground truth image data captured by a camera. For example, the image field extension system may generate background content that extends the background of the image generated by the camera. In one or more embodiments, a generative artificial intelligence (AI) algorithm generates the synthesized image data. For example, the generative AI algorithm may receive an image captured by a camera as input. The generative AI algorithm may analyze the content of the input image to determine which content to synthesize (e.g., generate) to extend the field of the input image.

In an example application, the image field extension system is used to fill a void area in a crop window that extends beyond the edge of the camera field of view. For example, the image field extension system may be integrated with a tool that automatically frames and crops image data, such as in video editing and video conference software applications. The image field extension system may automatically fill the void area in the crop window with content similar to content in the image captured by the camera. By generating the synthesized image data to constructively extend the field, the image field extension system can produce a composite image that fills the crop window. The composite image includes both the ground truth image data captured by the camera and the synthesized image data generated by the generative AI algorithm. In an example, the composite image may be centered on a particular subject within the imaged scene. For example, the composite image may be centered on an attendee (or participant) of a video conference. In this example application, the generative AI algorithm may synthesize additional content to produce plausible aesthetic content that enables providing a centered perspective of a subject when the subject is at the edge of the camera field of view. The image field extension system may communicate the composite image to a remote computer device for display. For example, the composite image may be remotely communicated for viewing at the computer displays of other attendees of the video conference.

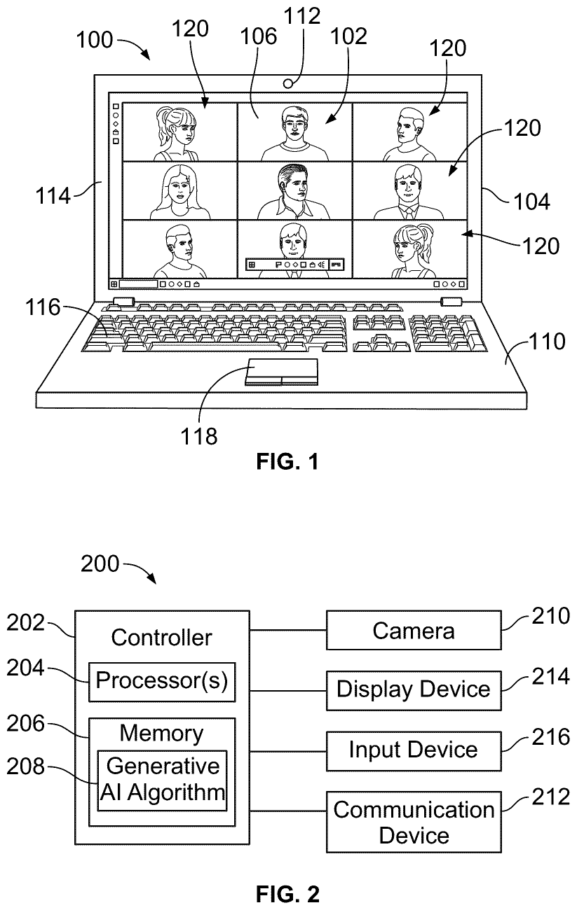

FIG. 1 illustrates a computer device 100 that displays a graphical user interface (GUI) 102 for a video conference. The computer device 100 in the illustrated example is a laptop computer. The computer device 100 has a cover panel 104 that includes a display screen 106. The cover panel 104 is pivotably connected to a base 110 of the computer device 100. The base 110 may include a keyboard 116, a touchpad 118, and computing hardware and circuitry. The computer device 100 may include a camera 112 that is integrated with the cover panel 108. For example, the camera 112 may be embedded within a bezel 114 of the cover panel 108 that surrounds the display screen 106. The GUI 102 is displayed by the computer device 100 on the display screen 106.

The GUI 102 in FIG. 1 may be generated by a video conferencing program (e.g., application). During a video conference, the video conferencing program may remotely transmit image data generated by the camera 112 to other computer devices for display. The GUI 102 displays content during the video conference. For example, the displayed content may include an array of multiple discrete frames 120. Each frame 120 is associated with a different attendee (e.g., participant) of a common video conference. Each frame 120 depicts image data provided by a video-enabled computer device corresponding to the attendee that is associated with the specific frame 120. In an example, the different frames 120 show video streams of different attendees of the video conference. For example, one of the frames 120 may display a video stream depicting a first attendee that is positioned in front of the computer device 100 and is captured in a field of view of the camera 112. The other frames 120 of the GUI 102 may display video streams depicting other attendees. The video streams may be live feeds. In an example, the attendees may be centered within the frames 120. For example, the video conferencing program may auto-frame and crop image data so the resultant image data displayed on the GUI 102 show the attendees centered within the frames 120. It may be aesthetically desirable for an attendee of a video conference to view other attendees centered within individual frames 120 as shown in FIG. 1.

The image field extension system described herein may be incorporated within the computer device 100 shown in FIG. 1. For example, the image field extension system may provide composite images that show attendees centered in the frame, for display on the GUI 102, even when one or more of the attendees is located at or proximate to an edge of the field of view of the respective camera. The image field extension system may operate to effectively (e.g., constructively) extend the imaged field of a camera so that an attendee that is at the edge of the camera's field of view can be shown centered in the respective frame 120 of the GUI 102. The image field extension system may function without adjusting the camera or instructing an attendee of the video conference to move towards the center of the camera's field of view.

At least one technical effect of the image field extension system may be providing a frame centered on a user (e.g., attendee) even when a window defining the frame extends beyond the edge of the camera's field of view. As a result, the user may be displayed in a more aesthetically desirable position than the user would appear without the intervention of the image field extension system. Another technical effect of the image field extension system may be that no bulky actuator or other additional hardware is required. For example, the image field extension system can effectively extend the field of view of a camera without an actuator to repoint (e.g., reposition) the camera based on a location of the user or another subject in the imaged scene. The image field extension system may operate using image data captured by a conventional camera set in a fixed position, such as the camera 112 of the laptop computer shown in FIG. 1.

FIG. 2 is a block diagram of the image field extension system 200 according to an embodiment. The image field extension system 200 includes a controller 202 that has one or more processors 204 and at least one tangible and non-transitory computer-readable storage medium (e.g., data storage device) 206, referred to herein as memory. The one or more processors 204 perform some or all of the operations of the image field extension system 200 described herein. The memory 206 may store program instructions (e.g., software) that are executed by the one or more processors 204 to perform the operations of the image field extension system 200. For example, the program instructions stored in the memory 206 may be executable by the one or more processors 204 to detect a subject in a foreground environment of an input image captured by a camera; determine that a crop window, positioned based on the subject, extends beyond an edge of the input image; input the input image and one or more frame parameters to a generative AI algorithm that generates synthesized image data to fill a void area of the crop window; produce a composite image that includes a portion of the input image in a first area and the synthesized image data in a second area; and communicate the composite image for display.

The one or more processors 204 represent hardware circuitry, such as one or more microprocessors, integrated circuits, microcontrollers, field programmable gate arrays, etc.). In a first example, the image field extension system 200 has only a single processor 204. In a second example, the image field extension system 200 has multiple processors 204 integrated within a single computer device (e.g., the computer device 100 shown in FIG. 1, a server, etc.). In a third example, the image field extension system 200 has multiple processors 204 that are integrated into different, discrete computer devices (e.g., personal computers, servers, cloud storage and/or computing devices, etc.). In the third example, the processors 204 may be communicatively connected to perform the operations of the image field extension system 200 described herein. For example, a first subset of the processors 204 may perform a first function of the image field extension system 200, and a second subset of the processors 204 may perform a second function of the image field extension system 200 based on communication with the first subset. References herein to the controller 202 and the one or more processors 204 encompass the different examples described above.

The memory 206 may include a generative AI algorithm 208. The generative AI algorithm 208 may generate new content in response to a query or prompt. The generative AI algorithm 208 may include or represent an artificial neural network and/or another machine learning algorithm. In an example, the generative AI algorithm 208 may include a generative adversarial network (GAN), a variational autoencoder (VAE), and/or the like. The generative AI algorithm 208 may receive an input image as a prompt. The generative AI algorithm 208 may analyze the content of the input image and transform the image into visual elements, which may be expressed as vectors, and generate synthesized image data based on the visual elements of the input image. In an example, the generative AI algorithm 208 and the program instructions to be executed by the one or more processors 204 to perform the operations of the image field extension system 200 may be stored in the same data storage device hardware. In another example, the memory 206 may include multiple different data storage devices accessible to the one or more processors 204. The generative AI algorithm 208 may be stored in a first data storage device, and the program instructions may be stored in a second data storage device.

The image field extension system 200 may include auxiliary components such as a camera 210, a communication device 212, a display device 214, and a user input device 216. The additional components may be operatively/operably connected to the controller 202 via wired and/or wireless communication links to permit the transmission of data (e.g., image data), commands, and other information in the form of signals. For example, the controller 202 may receive images captured (e.g., generated by the camera 210). The controller 202 may generate control signals that are transmitted to the communication device 212 and the display device 214 to control operation of these devices 212, 214. The image field extension system 200 may have additional components that are not shown in FIG. 2. In an alternative embodiment, the image field extension system 200 may lack one or more of the additional components that are shown in FIG. 2, such as the display device 214.

The camera 210 includes an optical sensor that captures (e.g., generates) image data representative of subject matter within a field of view of the camera 210 at the time that the image data is captured. The image data is generated based on light that impinges on the optical sensor. The light that impinges on the optical sensor may be reflected off objects in an imaged scene in the real world. The objects in the image scene can include one or more subjects in a foreground environment and elements in a background environment of the imaged scene. The image data captured by the camera 210 is referred to as ground truth image data that is an accurate reflection of the imaged scene within the field of view of the camera. The image data may include a series of images over time, representing a video. The camera 210 may be activated to generate image data depicting a subject for recording video, generating still images, and/or streaming video via a network (e.g., the Internet) to other computer devices. For example, an attendee may activate the camera 210 during a video conference to allow other participants of the video conference to view a video feed of the attendee.

In an example, the image field extension system 200 may be integrated with the computer device 100 shown in FIG. 1. The camera 210 may be the camera 112 that is on the cover panel 104 in FIG. 1. The display device 214 may include the display screen 106 and the hardware and software components that are used to display graphical content on the display screen 106. The input device 216 may include the keyboard 116 and the touchpad 118. The controller 202 and the communication device 212 may be integrated within the computing hardware and other circuitry housed within the base 110 of the computer device 100. In other examples, the image field extension system 200 may be integrated with one or more other types of computer device (other than a laptop computer), such as a desktop computer, a tablet computer, a smartphone, a standalone video conference hub device, a computer workstation, and/or the like.

The display device 214 includes a display screen for displaying graphical content to an observer. The display screen may be an LCD screen or the like. The display screen may be illuminated by an array of light emitting elements of the display device. The light emitting elements may be controlled by a graphical processing unit (GPU) of the display device 214. The display device 214 may be controlled by the controller 202 to selectively display composite images that are produced by the image field extension system 200.

The input device 216 is designed to receive user inputs (e.g., selections) from a user that interacts with the image field extension system 200. The input device 216 may include a touch sensitive screen or pad, a mouse, a keyboard, a joystick, a switch, physical buttons, and/or the like. The user may actuate the input device 216 to control at least some operations of the image field extension system 200. For example, the user may actuate the input device 216 to select or modify one or more settings of the image field extension system 200. For example, a user may select a frame parameter for composite images that are generated by the image field extension system 200. The frame parameter may characterize the dimensions of the composite images. For example, the frame parameter may be an aspect ratio, an orientation (e.g., portrait vs. landscape), a size, a zoom level, or the like. The input device 216 may also be used by a user to selectively activate and deactivate the image field extension system 200 and/or to open and close a video conferencing program on a computer device.

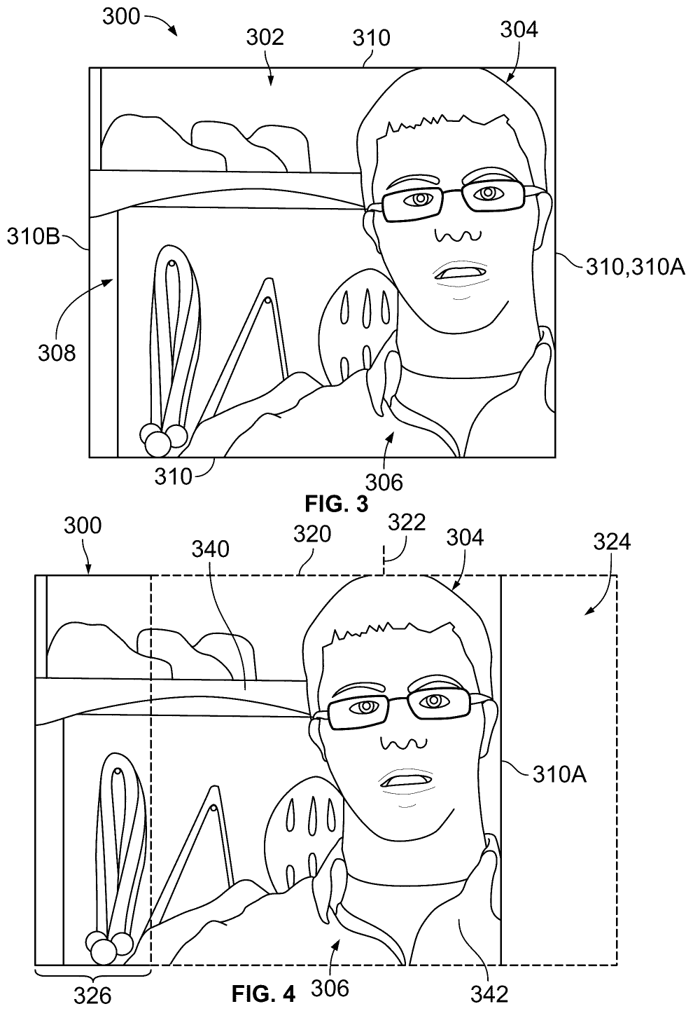

FIG. 3 illustrates an example image 300 that is captured by a camera. The image 300 depicts an imaged scene 302 that is in the real world. The imaged scene 302 includes a subject 304 in a foreground environment 306. The imaged scene 302 also has a background environment 308 behind the foreground environment 306. The image 300 contains ground truth image data captured by the camera based on light that impinges on an optical sensor of the camera. The camera that captured the image 300 may be the camera 210 of the image field extension system 200 shown in FIG. 2. The area of the image 300 may correspond to the field of view of the camera. For example, the edges 310 of the image 300 may represent the edges or ends of the camera's field of view. In an example, the image 300 may be captured by a camera during a video conference. For example, the camera 112 of the computer device 100 in FIG. 1 may capture the image 300. The subject 304 in the imaged scene 302 may be an attendee of the video conference.

The subject 304 in the imaged scene 302 of the image 300 is a single person. In other examples, the subject(s) in the foreground of an imaged scene may be multiple people, one or more animals, and/or one or more objects. The subject 304 is not centered in the image 300. The subject 304 is located closer to a first lateral edge 310A of the image 300 than a second lateral edge 310B, which is opposite the first lateral edge 310A. For example, the head of the subject 304 is more proximate to the first lateral edge 310A than to the second lateral edge 310B.

The controller 202 of the image field extension system 200 may obtain the image 300 as an input image. The image 300 is referred to herein as an input image 300. In an example, the controller 202 may receive the input image 300 from the camera 210 that generates the image 300. The camera 210 may automatically communicate images (e.g., image data) captured by the camera 210 to the controller 202, either immediately or periodically on a schedule. In another example, the controller 202 may obtain the input image 300 by accessing and retrieving the input image 300 from the memory 206 or another data storage device. For example, images captured by the camera 210 may be stored at least temporarily in the memory 206, and the controller 202 may access the memory 206 to obtain the input image 300 and other images. In another example, the controller 202 may obtain the input image 300 from a remote computer device via the communication device 212 of the image field extension system 200.

FIG. 4 illustrates a crop window 320 superimposed on the input image 300 according to an embodiment. The controller 202 may position the crop window 320 relative to the input image 300 based on a position of the subject 304. The crop window 320 is used to automatically frame and crop the ground truth image data to produce an image frame. The image frame may be uniquely associated with the subject 304. For example, the image frame that is produced may be displayed in one of the frames 120 of the GUI 102 shown in FIG. 1.

In an example, the controller 202 may analyze the input image 300 to detect the subject 304 in the foreground environment 306. The controller 202 may use one or more image analysis algorithms to detect the position of the subject 304 in the input image 300. The image analysis algorithm(s) may perform image segmentation, feature detection, edge detection, and/or the like. In one example, the image analysis algorithm(s) may search the input image 300 to detect characteristic features of a subject, such as eyes, a mouth, a nose, eyeglasses, and/or the like. In another example, the controller 202 may use a trained machine learning algorithm to perform object detection and classification. The machine learning algorithm may be an artificial neural network, such as a convolutional neural network. The machine learning algorithm may be trained to detect a class of subjects, such as people (e.g., faces), in the foreground environment of image data.

After detecting the subject 304 depicted in the input image 300, the controller 202 may determine a position for the crop window 320 based on the position of the subject 304. In an example, the controller 202 may center the crop window 320 relative to the subject 304. For example, the controller 202 may use one or more image analysis algorithms to analyze the image data of the input image 300 that depicts the identified subject 304. The controller 202 may analyze the image data to determine a centerline 322 and/or center point of the subject's head and/or face. The centerline 322 and/or center point are located at the lateral midpoint of the subject's head and/or face. The controller 202 may determine the centerline 322 and/or center point by determining a pixel or other base element of the input image 300 that is halfway between two lateral edges of the subject's 304 head, face, or single feature (e.g., the mouth or nose), or that is halfway between two paired features (e.g., the eyes, the ears, etc.). The centerline 322 and/or center point may be characterized by pixel coordinate values of the input image 300.

The controller 202 may position the crop window 320 so that the crop window 320 is laterally aligned with the centerline 322 of the subject 304 and/or is concentric with the center point of the subject 304. The crop window 320 is shown in FIG. 4 to assist in describing the functions of the controller 202 of the image field extension system 200. In an example, the controller 202 may not actually generate any output that shows the lines of a crop window positioned on an input image. For example, the controller 202 determines the position of the crop window 320 relative to the input image 300 by determining which pixels of the input image 300 would be within the crop window 320 as positioned based on the position of the subject 304. In another example, the controller 202 may indeed generate a graphic similar to FIG. 4, showing both the positioned crop window 320 and the input image 300. The controller 202 may display the graphic on the display device 214 to notify a user about portion(s) of the input image 300 that will be cropped out. For example, the controller 202 may retain the portion of the input image 300 within the crop window 320 and may crop out the portion(s) of the input image 300 outside of the crop window 320. In FIG. 4, the controller 202 may crop out (e.g., excise) a section 326 of the input image 300 along the second (e.g., left) edge 310B which is outside of the crop window 320.

After positioning the crop window 320 relative to the input image 300, the controller 202 determines whether any portion of the crop window 320 extends beyond an edge 310 of the input image 300. The controller 202 may compare coordinate values of the crop window 320 to coordinate values of the input image 300 to determine whether any portion of the crop window 320 is outside of the input image 300. In the illustrated example, the controller 202 determines that the crop window 320 extends beyond the first edge 310A of the input image 300 and defines a void area 324 within the crop window 320. The void area 324 is a portion of the crop window 320 outside of the input image 300 (e.g., that does not overlap with the input image 300). The void area 324 is void of image data. The void area 324 of the crop window 320 is outside of the camera's field of view.

The dimensions and shape of the crop window 320 may be determined by a frame parameter. The frame parameter may be a default setting, selected by a user using the input device 216, or the like. For example, the frame parameter may provide an aspect ratio for the crop window 320, length and width values for the crop window 320, an orientation of the crop window 320, and/or the like. The aspect ratio represents a proportional relationship between the crop window's width and height. One example aspect ratio is 16:9. The orientation of the crop window 320 can refer to portrait or landscape. The frame parameter may be selected based on a desired size and/or shape of a composite image (e.g., image frame) that is produced by the image field extension system 200. For example, the frame parameter may be selected based on dimensions of the frames 120 of the GUI 102 shown in FIG. 1, so that the composite images that are produced can be rendered and displayed on the GUI 102 within one of the frames 120.

Upon determining that the void area 324 is present, the controller 202 inputs the input image 300 to the generative AI algorithm 208. The generative AI algorithm 208 may analyze the input image 300 and generate synthesized image data to fill the void area 324 in the crop window 320.

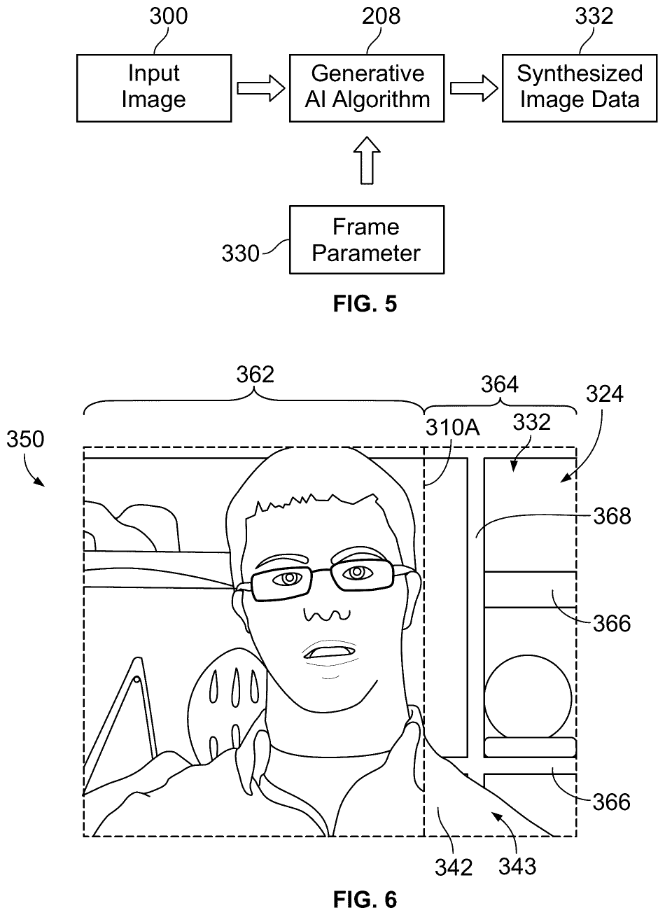

FIG. 5 is a block diagram showing a function of the generative AI algorithm 208 according to an embodiment. The generative AI algorithm 208 may receive, as inputs, the input image 300 and a frame parameter 330. The generative AI algorithm 208 may analyze the input image 300 and the frame parameter 330 to generate, as an output, synthesized image data 332. The generative AI algorithm 208 may generate the synthesized image data 332 based on content in the input image 300. The synthesized image data 332 may represent a plausible extension of the imaged scene 302 within the input image 300. For example, the synthesized image data 332 may be a plausible extension of the background environment 308 in the imaged scene 302.

The generative AI algorithm 208 generates the synthesized image data 332 to fill the void area 324. For example, the generative AI algorithm 208 may determine the dimensions of the void area 324 based on the frame parameter 330 and position of the crop window 320 relative to the input image 300. As described above, the frame parameter 330 may provide dimensions of the crop window 320. In another example, the controller 202 may determine the dimensions of the void area 324 and location of the void area 324 relative to the image 300, and may provide that information to the generative AI algorithm 208 as the frame parameter 330. The generative AI algorithm 208 generates synthesized image data 332 to fill the void area 324 based on the dimensions of the void area 324 and/or the crop window 320. For example, the generative AI algorithm 208 may only generate synthesized image data 332 within the dimensions of the void area 324.

In an example, the generative AI algorithm 208 may analyze more than just the content of the image 300 that is within the crop window 320 to determine the content to generate as the synthesized image data 332. For example, the generative AI algorithm 208 may analyze both the portion of the input image 300 that is within the crop window 320 and a second portion of the input image 300 that is outside of the crop window 320 to determine the content to generate. In a first example, the generative AI algorithm 208 may analyze the entire input image 300 to generate the synthesized image data 332 to fill the void area 324. In a second example, the generative AI algorithm 208 may analyze the entirety of the content in the input image 300 that depicts the background environment 308 of the imaged scene 302. The synthesized image data 332 may represent aesthetic content that plausibly extends the background environment 308 of the imaged scene 302. background environment 308 may be relatively static. In the illustrated example of the input image 300 shown in FIG. 4, the background environment 308 includes a shelf 340, objects on the shelf 340, and additional items hanging underneath the shelf 340. The generative AI algorithm 208 may generate the synthesized image data 332 to depict an extended section of the shelf 340, another shelf that is similar in appearance to the shelf 340, additional objects on the shelf 340 or another shelf, and/or additional items hanging up below the shelf 340 or another shelf.

In an example, the generative AI algorithm 208 may generate the synthesized image data 332 to match a perceived style of the background environment 308 of the input image 300. For example, the background environment 308 may be intentionally slightly blurred (e.g., out of focus) in the input image 300. If so, the generative AI algorithm 208 may generate the synthesized image data 332 to depict an extended section of the background that is also slightly blurred. As a result, the synthesized image data 332 in the void area 324 aesthetically appears similar to the background environment 308 depicted in the input image 300, like a natural extension of the background environment 308. To be clear though, the synthesized image data 332 does not accurately reflect the actual, real world content in the imaged scene 302 beyond the edge of the camera's field of view.

In an example, the generative AI algorithm 208 may determine if a portion of the foreground environment 306 extends into the void area 324. In the illustrated example, the generative AI algorithm 208 may determine that a portion of the subject 304 extends beyond the edge 310A of the input image 300 into the void area 324. The missing portion of the subject 304 includes the subject's left shoulder as covered by the subject's collared shirt 342. The generative AI algorithm 208 may be trained to follow specific rules. The rules may be set by default, selected by user preferences, and/or the like. In one example rule, the generative AI algorithm 208 may be permitted to generate synthesized image data 332 that depicts clothing of the subject 304. In this case then, the generative AI algorithm 208 may generate synthesized image data 332 that depicts a plausible extension of the collared shirt 342 at the left shoulder of the subject 304 in front of background content. The synthesized image data 332 that depicts plausible foreground content may be generated to match an aesthetic style of the foreground environment 306 as depicted in the image 300. For example, the generated foreground content in the void area 324 may be in sharper focus (e.g., clarity) than the generated background content in the void area 324.

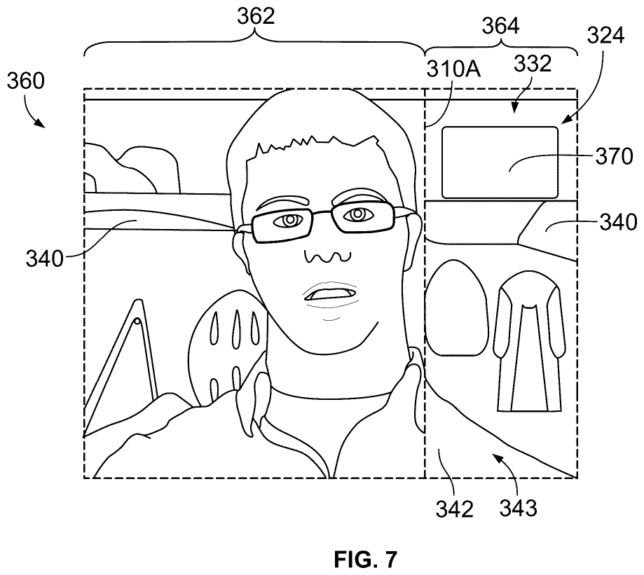

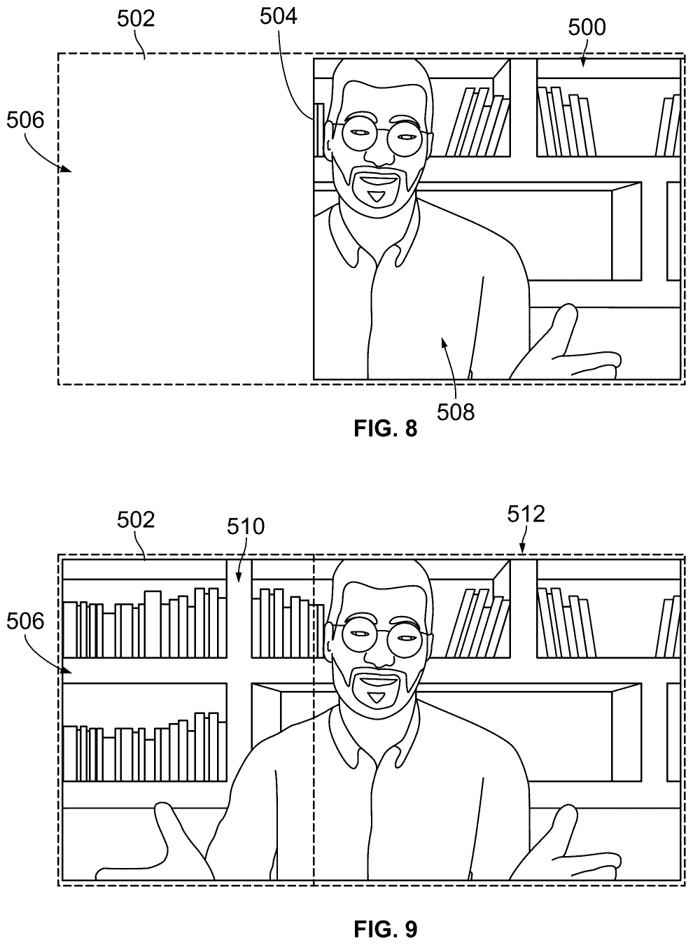

FIGS. 6 and 7 show two different composite images 350, 360 that may be generated by the controller 202 of the image field extension system 200 based on the input image 300 according to an embodiment. FIG. 6 shows a first composite image 350, and FIG. 7 shows a second composite image 360. Each of the composite images 350, 360 may be generated by inputting the input image 300 and the frame parameter 330 into the generative AI algorithm 208, as shown and described with reference to FIGS. 3 through 5. Each composite image 350, 360 has dimensions of the crop window 320. A respective first area 362 of each composite image 350, 360 is defined by the portion of the input image 300 that aligns with the crop window 320, as shown in FIG. 4. A respective second area 364 of each composite image 350, 360 is defined by respective synthesized image data 332 that is generated to fill the void area 324. The controller 202 may produce each of the composite images 350, 360 by cropping out the section 326 (shown in FIG. 4) of the input image 300 that is outside of the crop window 320 and stitching the synthesized image data 332 to the edge 310A of the input image 300 so that the synthesized image data 332 fills the void area 324.

In an example, the first composite image 350 only differs from the second composite image 360 in the content depicted by the synthesized image data 332 (e.g., the content filling the void area 324). For example, the synthesized image data 332 in the first composite image 350 depicts additional shelving 366, including an upright wall 368 that supports the shelving 366 and objects on the shelves. The synthesized image data 332 in the second composite image 350 depicts an extended section of the shelf 340, additional items hanging below the shelf 340, and a sign 370 above the shelf. The synthesized image data 332 in both composite images 350, 360 shows a plausible extension of the subject's collared shirt 342 at the subject's left shoulder 343 in front of background content.

All of the content depicted in the second areas 364 of the composite images 350, 360 is synthesized image data 332 generated by the generative AI algorithm 208. For example, the differences between the first and second composite images 350, 360 may be attributable to two different iterations of inputting the input image 300 and frame parameter 330 into the generative AI algorithm 208. The generative AI algorithm 208 is designed to generate plausible content, though not accurate to the actual real-world environment. The synthesized image data 332 may not be consistent over multiple iterations, even if the inputs are the same.

In an example, after producing a composite image, such as the first composite image 350 or the second composite image 360, the controller 202 may communicate the composite image to a remote computer device for display. For example, the controller 202 may control the communication device 212 to transmit the composite image 350 to a remote server or computer. In an example application, the composite image 350 may be an image frame that is part of a video stream or feed during a video conference. The video stream may be transmitted to multiple computer devices that are participating in the video conference to enable the attendees to view the subject 304 centered in the frame. For example, the composite image 350 may be displayed on the GUI 102 shown in FIG. 1 in one of the designated frames 120. The subject 304 is centered in the frame 120, even though the subject 304 is not centered within the original image 300 captured by camera.

The content that is depicted by the synthesized image data 332 may be relatively static. For example, the synthesized image data 332 does not depict the face of the subject 304, which may be more active as the subject 304 blinks, speaks, looks around, and moves his head during a video conference. In an example, the controller 202 may use the same synthesized image data 332 to produce multiple composite images over time. For example, the input image 300 may be a first image, and the controller 202 may receive a series of images captured by the same camera after capturing the first image. The series of images may be sequential image frames of a video. The controller 202 may position the crop window 320, crop the image data, and stitch the same synthesized image data 332 onto each of the images in the series to produce a series of composite images. The series of composite images may be remotely communicated for display on remote computer devices, such as during a video conference.

In an example, the controller 202 may repeat the procedure described with reference to FIGS. 3 through 6 to produce new synthesized image data in response to detecting occurrence of a designated triggering event. One example of a designated triggering event is if the subject 304 in the foreground environment 306 is determined to have moved beyond a threshold distance from the initial position of the subject 304. Movement of the subject 304 may change the size of the void area 324. If the void area 324 increases in size, the controller 202 may perform the image extension procedure again to generate new synthesized image data to fill the larger void area 324. A second example triggering event may be that the controller 202 detects the background environment 308 changes by at least a threshold amount. For example, the controller 202 may analyze the colors and other parameters in the background environment of subsequent images captured by the camera. For example, if the lighting changes in a room, the controller 202 may detect that the changed appearance of the background is beyond the threshold amount, and may repeat the procedure to generate new synthesized image data for the void area. In a third example, the controller 202 may be scheduled to automatically refresh the synthesized image data at a designated interval based on time or number of composite images generated.

In an example, the controller 202 may use the synthesized image data 332 in FIG. 6 (or FIG. 7) to generate a composite background image. The controller 202 may excise the foreground environment from the composite background image. The composite background image may be used to generate a series of image frames over time, such as image frames for a video feed during a video conference. For example, the controller 202 may receive a series of subsequent images captured by the same camera that captured the input image 300. For each of the subsequent images, the controller 202 may analyze the image to detect and extract the image data within the crop window 320 that depicts the foreground environment, which is referred to herein as foreground image data. The controller 202 may produce a series of image frames by overlaying the foreground image data of each of the images onto the composite background image. The composite background image, which includes the synthesized image data 332, may remain constant. The foreground environment in the series of image frames changes over time due to the different foreground image data that is overlaid on the composite background image. The series of image frames may depict the subject 304 in the imaged scene 302 in front of the composite background image at different times.

Reference is now made back to the rules that govern the content generation by the generative AI algorithm 208. In another example rule, the generative AI algorithm 208 may be prohibited from generating synthesized image data that depicts a portion of the subject 304 that is used to communicate. Such portions of a person can include the head (e.g., face) and the hands. For example, if a portion of the subject 304 extends beyond the edge of the image 300 into the void area 324, the generative AI algorithm 304 may only generate clothing of the subject 304 in a pose in which the subject's missing arm is down at the subject's side.

In another example rule, if the input image shows only one hand of the subject, the generative AI algorithm 208 may be permitted to generate synthesized image data for the missing hand based on the appearance of the hand that is captured in the input image. FIG. 8 shows an example input image 500 within a crop window 502. The crop window 502 extends beyond an edge 504 of the input image 500 to define a void area 506. In this example, the subject 508 in the input image 500 is a person. The subject's right arm is cut off, but a portion of the left arm and left hand are visible in the input image 500. The controller 202 may input the input image 500 into the generative AI algorithm 208 with a frame parameter 330 that describes the dimensions and position of the crop window 502. In an example, the generative AI algorithm 208 may generate synthesized image data 510 that is shown in FIG. 9.

FIG. 9 shows a composite image 512 that may be generated by the controller 202 of the image field extension system 200 based on the input image 500 according to an embodiment. The synthesized image data 510 fills the void area 506. In the illustrated example, the generative AI algorithm 208 generates the synthesized image data 510 to depict a portion of the subject's right arm and right hand. The generative AI algorithm 208 may determine the position and appearance of the right hand based on the position and appearance of the left hand, although the right hand is not a replica or mirror-image of the left hand. The synthesized image data 510 may also depict a plausible extension of the background environment in the input image 500. In the illustrated example, the background environment that is synthesized may include block shelving and books on the shelves.

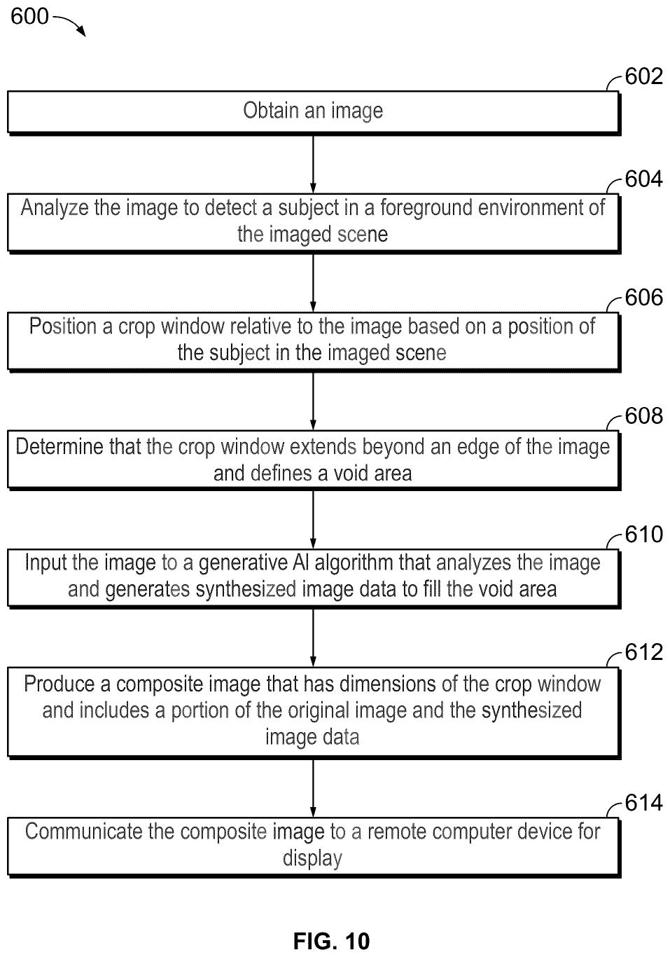

FIG. 10 is a flow chart 600 of a method of extending an image field according to an embodiment. The method may constructively extend a field of view of a camera by synthesizing plausible content adjacent to one or more edges of an image captured by the camera. The method may be performed entirely or in part by the controller 202 (e.g., the one or more processors 204) of the image field extension system 200. The method optionally may include at least one additional step than shown, at least one fewer step than shown, and/or at least one different step than shown.

At step 602, the controller 202 obtains an input image. The input image is captured by a camera and depicts an imaged scene. The input image may be obtained from the camera, retrieved from a storage device, and/or received from a computer device. At step 604, the controller 202 may analyze the input image to detect a subject in the foreground environment of the imaged scene. At step 606, the controller 202 may position a crop window relative to the input image based on a position of the subject in the imaged scene. For example, the controller 202 may position the crop window so that the subject is centered within the crop window. At step 608, the controller 202 may determine that the crop window, which frames a portion of the input image, extends beyond an edge of the input image and defines a void area.

At step 610, the controller 202 may input the input image to a generative AI algorithm. The generative AI algorithm may analyze the input image and generate synthesized image data to fill the void area in the crop window. The generative AI algorithm may generate the synthesized image data based on content in the input image to represent a plausible extension of the imaged scene. The method may include inputting a frame parameter to the generative AI algorithm with the input image. The frame parameter may be obtained by the controller 202, and may indicate dimensions of the crop window. The controller 202 may input the frame parameter so the generative AI algorithm generates the synthesized image data to fill the void area based on the dimensions of the crop window, and void area thereof.

At step 612, the controller 202 may produce a composite image that has dimensions of the crop window. The composite image may be produced so that a first area is defined by the portion of the input image that aligns with the crop window and a second area of the composite image is defined by the synthesized image data. At step 614, the controller 202 may communicate the composite image to a remote computer device for display. Optionally, the composite image may be a composite background image. The method may include generating multiple image frames of a video. The controller 202 may generate the multiple image frames by overlaying, on the composite background image, foreground image data that depicts the subject in the foreground environment of the imaged scene at different times.

### Closing Statements

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), complex instruction set computer (CISC), application specific integrated circuits (ASICs), field-programmable gate arrays (FPGAs), logic circuits, and any other circuit or processor capable of executing the functions described herein. Additionally, or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

In one embodiment, the image field extension system may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, SVMs, Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Further, in the following claims, the phrases “at least A or B”, “A and/or B”, and “one or more of A and B” (where “A” and “B”represent claim elements), are used to encompass i) A, ii) B or iii) both A and B.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. An image field extension system comprising:
a memory configured to store program instructions; and
one or more processors operably connected to the memory, wherein the program instructions are executable by the one or more processors to:
obtain an input image captured by a camera, the input image depicting an imaged scene;
determine that a crop window, positioned to frame a portion of the input image, extends beyond an edge of the input image and defines a void area within the crop window; and
input the input image to a generative artificial intelligence (AI) algorithm, the generative AI algorithm configured to analyze the input image and generate synthesized image data to fill the void area in the crop window, wherein the generative AI algorithm is configured to generate the synthesized image data based on content in the input image to represent a plausible extension of the imaged scene.

2. The image field extension system of claim 1, wherein the generative AI algorithm is configured to generate the synthesized image data to represent a background environment of the imaged scene.

3. The image field extension system of claim 1, wherein the one or more processors are configured to position the crop window relative to the input image based on a subject in a foreground environment of the imaged scene.

4. The image field extension system of claim 3, wherein the one or more processors are configured to:
analyze the input image to detect the subject in the foreground environment; and
position the crop window relative to the input image so that the subject is centered within the crop window.

5. The image field extension system of claim 1, wherein the one or more processors are configured to produce a composite image having dimensions of the crop window, wherein a first area of the composite image is defined by the portion of the input image that aligns with the crop window and a second area of the composite image is defined by the synthesized image data.

6. The image field extension system of claim 5, wherein the one or more processors are configured to communicate the composite image to a remote computer device for display.

7. The image field extension system of claim 5, wherein the composite image is a composite background image, and the one or more processors are configured to overlay image data depicting a foreground environment of the imaged scene over the composite background image.

8. The image field extension system of claim 5, wherein the composite image is a composite background image, and the one or more processors are configured to generate multiple image frames that depict a subject in the imaged scene in front of the composite background image at different times.

9. The image field extension system of claim 5, wherein the one or more processors are configured to obtain a second input image and produce an updated composite image based on the second input image in response to the one or more processors detecting occurrence of a designated triggering event.

10. The image field extension system of claim 1, wherein responsive to determining that a subject in a foreground environment of the imaged scene extends into the void area of the crop window, the generative AI algorithm is configured to generate the synthesized image data within the void area to depict clothing of the subject.

11. The image field extension system of claim 1, wherein the generative AI algorithm is configured to analyze both the portion of the input image that is within the crop window and a second portion of the input image that is outside of the crop window to generate the synthesized image data to fill the void area of the crop window.

12. The image field extension system of claim 1, wherein the one or more processors are configured to obtain a frame parameter that indicates dimensions of the crop window and input the frame parameter to the generative AI algorithm so the generative AI algorithm generates the synthesized image data to fill the void area based on the dimensions of the crop window.

13. A method of extending an image field, the method comprising:
obtaining an input image captured by a camera, the input image depicting an imaged scene;
determining that a crop window, positioned to frame a portion of the input image, extends beyond an edge of the input image and defines a void area within the crop window; and
inputting the input image to a generative artificial intelligence (AI) algorithm, the generative AI algorithm configured to analyze the input image and generate synthesized image data to fill the void area in the crop window, wherein the generative AI algorithm is configured to generate the synthesized image data based on content in the input image to represent a plausible extension of the imaged scene.

14. The method of claim 13, further comprising producing a composite image having dimensions of the crop window, wherein a first area of the composite image is defined by the portion of the input image that aligns with the crop window and a second area of the composite image is defined by the synthesized image data.

15. The method of claim 14, further comprising communicating the composite image to a remote computer device for display.

16. The method of claim 14, wherein the composite image is a composite background image, and the method comprises generating multiple image frames of a video by overlaying, over the composite background image, foreground image data depicting a subject of the imaged scene at different times.

17. The method of claim 13, further comprising:
analyzing the input image that is obtained to detect a subject in a foreground environment of the imaged scene; and
positioning the crop window relative to the input image so that the subject is centered within the crop window.

18. The method of claim 13, further comprising:
obtaining a frame parameter that indicates dimensions of the crop window; and
inputting the frame parameter to the generative AI algorithm so the generative AI algorithm generates the synthesized image data to fill the void area based on the dimensions of the crop window.

19. A computer program product comprising a non-transitory computer readable storage medium, the non-transitory computer readable storage medium comprising computer executable code configured to be executed by one or more processors to:
obtain an input image captured by a camera, the input image depicting an imaged scene;
determine that a crop window, positioned to frame a portion of the input image, extends beyond an edge of the input image and defines a void area within the crop window; and
input the input image to a generative artificial intelligence (AI) algorithm, the generative AI algorithm configured to analyze the input image and generate synthesized image data to fill the void area in the crop window, wherein the generative AI algorithm is configured to generate the synthesized image data based on content in the input image to represent a plausible extension of the imaged scene.

20. The computer program product of claim 19, wherein the computer executable code is configured to be executed by the one or more processors to produce a composite image having dimensions of the crop window, wherein a first area of the composite image is defined by the portion of the input image that aligns with the crop window and a second area of the composite image is defined by the synthesized image data.
